(19) United States
(12) Patent Application Publication
(10) Pub. No.: US 2017/0108146 A1
(43) Pub. Date: Apr. 20, 2017

(54) SYSTEMS AND METHODS FOR A PIPE SUPPORT

(71) Applicant: Pipeline Products Specialty Company, Houston, TX (US)

(72) Inventors: Jules Francis Broussard, Houston, TX (US); Arthur Milton Urech, III, Katy, TX (US)

(21) Appl. No.: 15/139,869

(22) Filed: Apr. 27, 2016

Related U.S. Application Data
(60) Provisional application No. 62/155,536, filed on May 1, 2015.

(51) Int. Cl. F16L 3/16; F16L 1/028; F16L 1/024

(52) U.S. Cl. CPC F16L 3/16; F16L 1/0243; F16L 1/028

(57) ABSTRACT

Embodiments disclosed herein describe systems and methods a MAPSS, which is configured to receive, support, and couple pipelines. Additionally, the dynamic pipe support system may be configured to rotationally, vertically, linearly, and angular move. Utilizing the MAPSS, pipelines may be mounted on the pipe support systems. Based on the layout of the MAPSS, the alignment of the MAPSS may be changed. Therefore, the pipe supports may be dynamically changed to fit the requirements of the pipelines without having the reconfigure and reposition the entire pipe support system.

### CROSS-REFERENCE TO RELATED APPLICATIONS

This application claims a benefit of priority under 35 U.S.C. §119 to Provisional Application No. 62/155,536 filed on May 1, 2015, which is fully incorporated herein by reference in its entirety.

### BACKGROUND INFORMATION

Field of the Disclosure

Examples of the present disclosure are related to systems and methods for a pipe support. More particularly, embodiments relate to a pipe support with a rotatable and hinged mount, wherein a pipeline is configured to be positioned on a butterfly mount.

Background

Conventionally, oil and gas are transported from a first location to a second location through pipelines. The pipelines may be made from steel or plastic tubes, which may be buried below or elevated above a ground surface.

Either way, the pipelines are secured in place via pipe supports. Pipe supports are design elements that are configured to transfer the load of a pipeline to the supporting structures. The load may include the weight of the pipeline, the content the pipeline carries, all of the pipe fittings, etc.

Conventional pipe supports are static and fixed in place, and do not allow a pipeline to be rotationally, horizontally, or angularly adjusted while positioned on the pipe support. Accordingly, when laying pipelines on conventional pipe supports, it is required determine the exact position, alignment, and layout of the entire pipe support system before fixing the pipe support in the ground. However, determining the layout of the entire pipe support system before actually positioning the pipe support system may be a difficult or impossible task based on environmental factors and unforeseen circumstances.

Furthermore, the positioning of the pipelines and pipe supports will change over time due to environmental factors. Conventionally, when the environmental factors change, the layout of the pipelines and pipe supports must be manually repositioned. This leads to the arduous and costly task of reconfiguring the pipelines and pipe supports.

Accordingly, needs exist for more effective and efficient systems and methods for dynamic pipe supports that are configured to vertically, horizontally, rotate, and angular move.

### SUMMARY

Embodiments disclosed herein describe systems and methods a modular adjustable pipeline support system (MAPSS), wherein the MAPSS may be configured to receive, support, and couple pipelines. Additionally, pipe supports within the MAPSS may be configured to rotationally, horizontally, and angular move. Utilizing the MAPSS, pipelines may be mounted on the dynamic pipe supports based on the layout of the MAPSS. This may allow the MAPPS to be dynamically changed to fit the requirements of the pipelines without having the reconfigure and reposition each of the dynamic pipe supports within the entire MAPSS.

A pipe support system may include a base, shaft, mount, rotational disk, ears, spool, and butterfly mount.

The base may be a foundation that is configured to support the other elements of pipe support system and a pipeline. The base may be the lowest part of pipe support system. The base may include a platform and a shaft mount. The platform may be configured to increase the surface area of the base, which may disperse weight received by the pipeline support system to the ground. The shaft mount may be a channel that is configured to receive the shaft.

The shaft may be a telescopic column, wherein a proximal end of the shaft may be configured to be inserted into the shaft mount. Through compression the shaft may be configured to transfer the weight of the elements above the shaft to the base. The shaft may be an elongated cylindrical that is configured to extend and retract to adjust a vertical offset and/or distance between a bottom of the pipe support system to the top of the pipe support system. In other embodiments, the distance between the bottom and the top of the pipe support system may be changed via threads positioned on a distal or proximal ends of the shaft and threads positioned on the base and/or the mount. Responsive to turning the shaft, base, or mount, the distance between the bottom and top of the pipe support may change based on the direction of rotation of the shaft, base, and/or mount.

The mount may be a structure that is configured to couple with a distal end of the shaft. The mount may include threads that are configured to interface with the threads on the distal end of the shaft to secure the mount in place. The mount may also include a rotational interlocking system. The rotational interlocking system may be configured to engage a rotational lock with the rotational disk to secure the rotational disk in place. Additionally, the rotational lock may be configured to disengage with the rotational disk to allow the rotational disk to be rotated.

The rotational disk may be a cylindrical platform that is configured to be coupled with the mount. The rotational disk may be configured to rotate when the rotational interlocking system is disengaged to adjust the direction that a butterfly mount faces. Additionally, the rotational disk may be configured to support the butterfly mount via a first ear and a second ear.

The first and second ears may be projections positioned on opposite sides of the rotational disk. The projections may include orifices configured to receive a spool, wherein the orifices may be vertically offset from the face of the rotational disk. Accordingly, when the spool is positioned within the orifices, there may a space between the spool and the face of the rotational disk.

The spool may be a cylindrical structure that is configured to be inserted into the first ear to the ear. Responsive to a spool being inserted into ears, the spool may be extended to apply pressure against the inner sidewalls of the ears to be secured in place. Additionally, the spool may be configured to be inserted through orifices within the butterfly mount.

The butterfly mount may be a structure that is configured to receive a pipeline. The butterfly mount may include convex inner sidewalls that are configured to support a pipeline when the pipeline is positioned on the butterfly mount. The sidewalls of the butterfly mount may be configured to project outward so that the pipeline may be positioned on the sidewalls.

The butterfly mount may also include orifices positioned on sides of the butterfly mount, wherein the spool is configured to be positioned through the orifices. When the spool is positioned through the butterfly mount, the butterfly mount may be secured to the mount. However, when secured, the butterfly mount may be freely tilted upward or downward to a desired angle based on the positioning of a pipeline. Additionally, when secured, the butterfly mount may be rotated by rotating the rotational disk.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts two views of a modular adjustable pipeline support system, according to an embodiment.

FIG. 2 depict various side views of a modular adjustable pipeline support system, according to an embodiment.

FIG. 3 depict various views of a rotational disk, ears, spool, and butterfly mount, according to an embodiment.

FIG. 4 depicts a top view of a modular adjustable pipeline support system, according to an embodiment.

FIG. 5 depicts a bottom view of a modular adjustable pipeline support system, according to an embodiment.

FIG. 6 depicts a method utilizing a modular adjustable pipeline support system, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Embodiments disclosed herein describe systems and methods a dynamic pipe support, which is configured to receive, support, and couple pipelines. Additionally, the dynamic pipe support system may be configured to vertically, linearly, and angular move. Based on the layout of the pipeline system, the alignment of the dynamic pipe support system may be changed. Therefore, the pipe supports may be dynamically changed to fit the requirements of the pipelines without having the reconfigure and reposition the entire pipe support system.

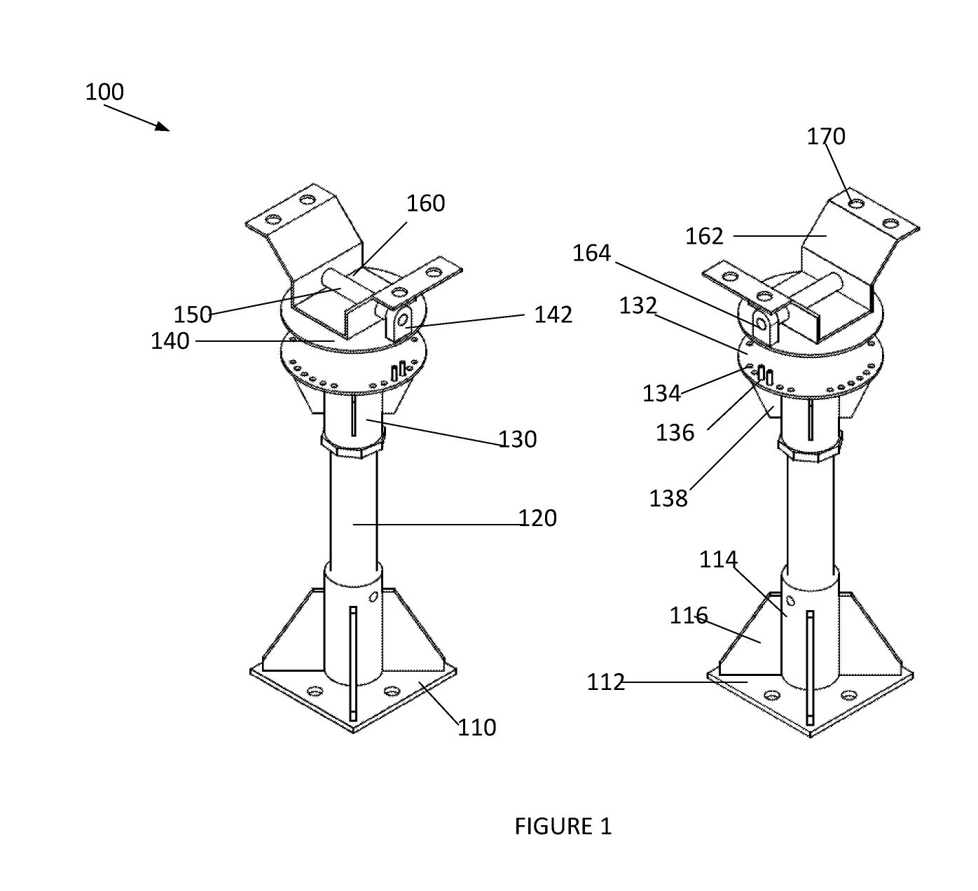

FIG. 1 depicts two views of a MAPSS 100, according to embodiments. Pipeline support may include a base 110, shaft 120, mount 130, rotational disk 140, ears 142, spool 150, and butterfly mount 160.

Base 110 may be a foundation of dynamic MAPSS 100 that is configured to support the other elements of MAPSS 100. Base 110 may be the lowest part of MAPSS 100, and be configured to be coupled with a proximal end of shaft 120. Base 110 may include a platform 112, shaft mount 114, and fins 116.

Platform 112 may be a flat surface that is configured to increase a ground surface area that is adjacent to base 110. Platform 112 may be configured to disperse weight received by the base 110 to the ground that is adjacent to platform 112.

Shaft mount 114 may be a projection with fins 116, wherein fins 116 extend away from shaft mount 114. The projection may be a hollow, cylindrical channel that is configured to receive shaft 120. In embodiments, the inner sidewalls of the shaft mount 114 may include threads, wherein shaft 120 may be screwed into shaft mount 114. In other embodiments, the inner sidewalls of the shaft mount 114 may be flat, such that shaft 120 may be slid into shaft mount 114.

Fins 116 may be structural supports that are positioned along an outer circumference of shaft mount 114. In embodiments, at least four fins 116 may be coupled to shaft mount 114. Each of the fins 116 may be configured to disperse weight received by shaft mount 114 to platform 112. Each of the fins 116 may be substantially triangular in shape, wherein a lower leg of fins 116 may extend from the circumference of shaft mount 114 to a corner of platform 112. Thus, the length of the lower legs of fins 116 may be maximized. In embodiments, each of the fins 116 may include a planar top edge and a planar side edge, and an angled fin 116, wherein the planar top edge is perpendicular to the planar side edge. This configuration may further assist in dispersing the weight received by shaft mount 114 to platform 112.

Shaft 120 may be a variable length column that is configured to couple with base 110 and mount 130. Shaft 120 may be configured to transfer the weight of elements above shaft 120 to base 110. Shaft 120 may be an elongated cylinder that is configured to extend and retract to adjust the vertical offset and/or distance between base 110 and mount 130.

In other embodiments, the distance between base 110 and mount 130 may be changed via threads positioned on the distal end and proximal end of shaft 120, and corresponding threads positioned on base 110 and/or mount 130. Responsive to turning shaft 120, the distance between base 110 and mount 130 may elongate or shorten based on the direction of turning and the threads.

Mount 130 may be a structure that is configured to couple with a distal end of shaft 120. Mount 130 may be configured to provide structural supports to elements of positioned on the upper portion of pipeline support 100. Mount 130 may include a hollow cylinder, wherein threads may be positioned on an inner surface of the hollow cylinder. The threads on the inner surface of mount 130 may be configured to receive threads positioned on the distal end of shaft 120, wherein shaft 120 may be screwed into the hollow cylinder. However, in other embodiments, the inner surface of the hollow cylinder may be flat, which may allow shaft 120 to be slid into the hollow cylinder. Mount 130 may include circular platform 132, orifices 134, rotational locks 136, and fins 138.

Circular platform 132 may be a circular disk at a distal end of mount 130. Circular platform 132 may be configured to allow rotational disk 140 to rotate, while also supporting rotational disk 140 and butterfly mount 150. The diameter of circular platform 132 may be substantially greater than the diameter of shaft 120.

Positioned adjacent to a circumference of circular platform 132 may be a plurality of orifices 134 that extend in a direction in parallel to a linear axis of shaft 120. Orifices 134 may extend through the height of circular platform 132 and be configured to receive rotational locks 136, wherein rotational locks 136 may extend through orifices 134. Responsive to rotational locks 136 being inserted through orifices 134 while coupled to rotational disk 140, rotational disk 140 may not be able to rotate and may be fixed in a rotational plane. However, responsive to decoupling rotational locks 136 from orifices 134 and/or rotational disk 140, rotational disk 140 may be rotated.

Fins 138 may be structural supports that are positioned along an outer circumference of mount 130. In embodiments, at least four fins 138 may be coupled to the outer circumference of mount 130. Each of the fins 138 may be configured to disperse weight received by mount 130 to shaft 120. Each of the fins 138 may be substantially triangular in shape, wherein an upper leg of fins 138 may extend from the circumference of mount 130 to the circumference of circular platform 132, wherein adjacent fins 138 may be positioned perpendicular to one another. This may maximize the length of the upper legs of fins 116. Additionally, there may not be orifices 134 that are positioned proximate to the lower legs of fins 116. Therefore, a single fin 116 may not bear the majority of the weight applied to mount 130. Furthermore, by not including orifices 134 over the lower legs of fins 116, the structural integrity of mount 130 may remain intact.

Rotational disk 140 may be a cylindrical surface that is configured to be coupled with mount 130. In embodiments, a face of rotational disk 140 may be substantially the same shape as the face of circular platform 132, wherein the face of rotational disk 140 is configured to be positioned adjacent to the face of circular platform 132. Rotational risk 140 may be configured to rotate to adjust the direction that butterfly mount 150 faces.

In embodiments, rotational locks 136 may be configured to couple with a lower face of rotational disk 140. When rotational locks 136 are inserted into orifices 134 while rotational locks 136 are coupled to rotational disk 140, rotational disk 140 may not be able to rotate and may be fixed in a rotational plane. However, responsive to decoupling rotational locks 136 from orifices 134, rotational disk 140 may be rotated.

Rotational disk 140 may include a pair of ears 142, wherein each of the ears 142 may be a projection positioned on opposite sides of rotational disk 140. The projections may include orifices 142 that extend through ears 142 in a direction that is perpendicular to the longitudinal axis of shaft 120. Orifices 142 may be configured to receive spool 150.

In embodiments, orifices 142 may be vertically offset from the face of rotational disk 140, and be positioned perpendicular to orifices 134. When spool 150 is positioned within orifices 142, there may be a space between spool 150 and the face of rotational disk 140, which may allow butterfly mount 160 to be inclined and/or declined. Additionally, pairs of rotational locks 136 may be positioned below each ear 142. Therefore, a user may know the placement of the rotational locks 136 without decoupling rotational locks 136 from orifices 134.

Spool 150 may be a cylindrical structure that is configured to extend from the first ear 142 to the second ear 142. Responsive to the spool 150 being inserted into ears 142, spool 150 may exert force against the inner sidewalls of ears 142 to be secured in place. Additionally, spool 150 may be configured to be inserted through orifices positioned on the butterfly mount 160.

Butterfly mount 160 may be a structure that is configured to receive a pipeline. Butterfly mount 160 may include convex inner sidewalls 162 that are configured to support a pipeline when the pipeline is positioned adjacent to, and on, butterfly mount 160. The sidewalls 162 of the butterfly mount 160 may be configured to project outward at an upward angle from the center of butterfly mount 160 so that a pipeline may be positioned and secured in place on sidewalls 162.

Butterfly mount 160 may also include orifices 164 positioned on sides of butterfly mount 160, wherein orifices 164 may be positioned in a direction perpendicular to a linear axis of shaft 120. In embodiments, spool 150 may configured to be positioned through orifices 164.

When spool 150 is positioned through orifices 164, butterfly mount 160 may be secured to mount 130. When secured, butterfly mount 160 may be rotated upward or downward to a desired angle based on the positioning of a pipeline. In embodiments, when secured, butterfly mount 160 may freely rotate upward or downward. Additionally, when secured, butterfly mount 160 may be rotated by rotating rotational disk 140.

Accordingly, the vertical height, tilt, and angular direction of a face of butterfly mount 160 may dynamically change, even after installation of pipeline support 100 within the ground.

Additionally, butterfly mount 160 may also include tie orifices 170 for U-Bolts. Mounting tie orifices 170 may be configured to extend through butterfly mount in a direction that is parallel to the linear axis of shaft 120. In embodiments, tie orifices 170 may be configured to receive U-Bolts that extend around a circumference of a pipeline. Utilizing the U-Bolts and tie orifices 170, the pipeline may be secured within butterfly mount 160.

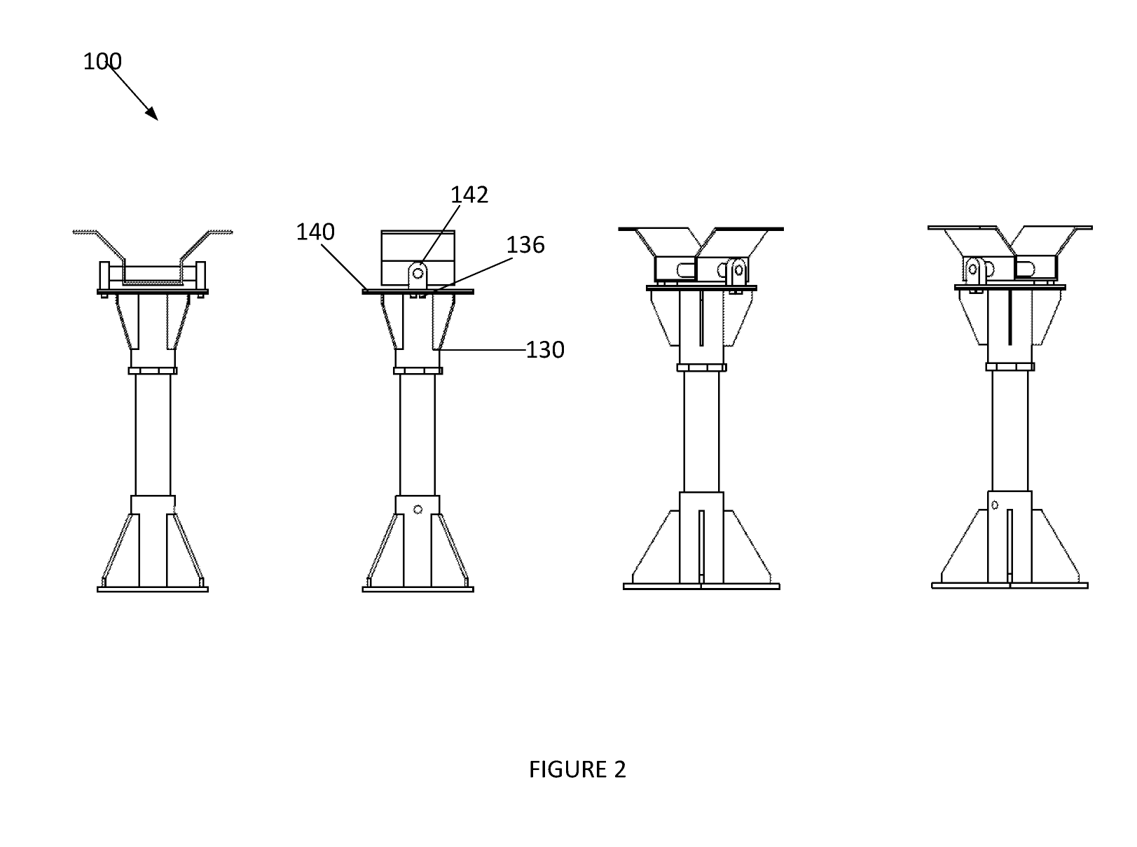

FIG. 2 depict various side views of dynamic pipeline support 100, according to embodiments. Elements depicted in FIG. 2 are discussed above. Therefore, for the sake of brevity an additional description of these elements is omitted.

As depicted in FIG. 2, rotational locks 136 are configured to extend through orifices 134 positioned through the face of circular platform 132. Rotational locks 136 may be bolts, screws, fasteners, etc. configured to couple mount 130 and rotational disk 140. The rotational locks 136 may include a first end configured to be inserted into receiving orifices positioned into ears 142, and a second end configured to extend through rotational disk 140.

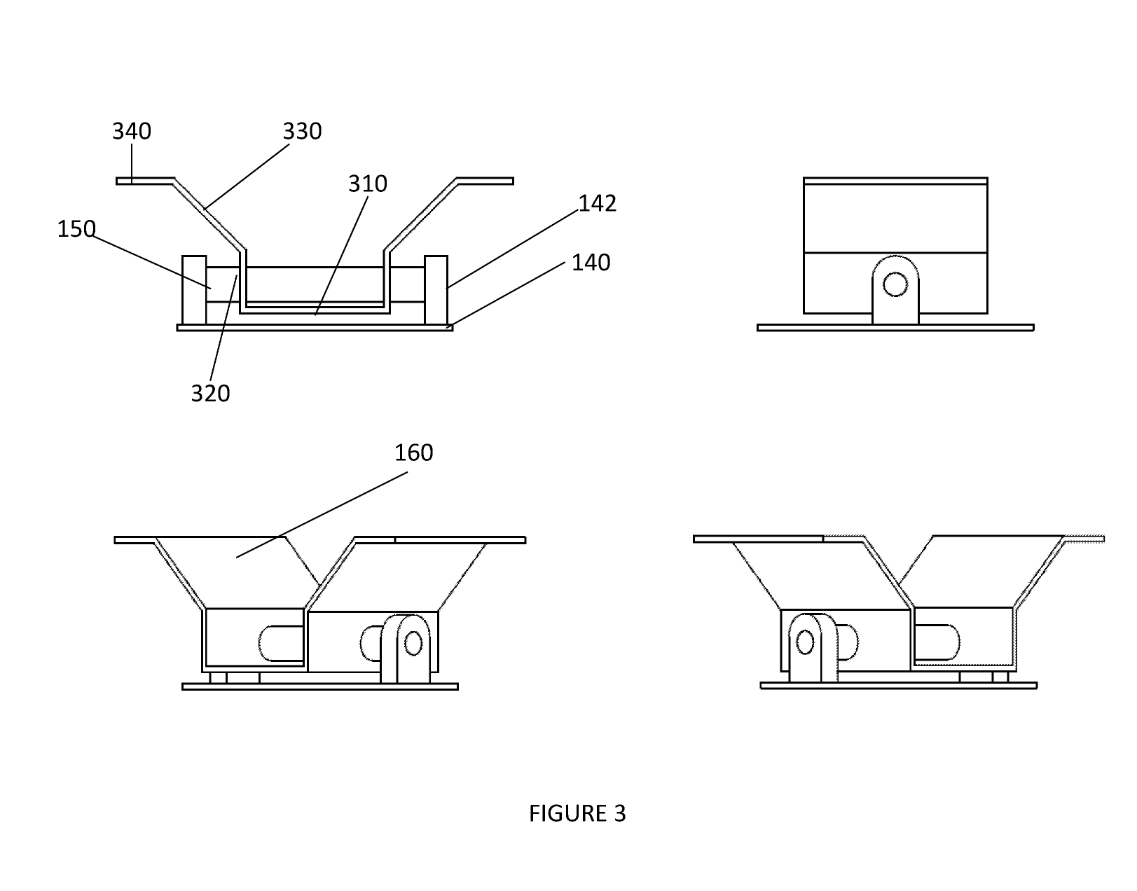

FIG. 3 depict various views of a rotational disk 140, ears 142, spool 150, and butterfly mount 160, according to embodiments. As depicted in FIG. 3, butterfly mount 160 may have a lower base 310, inner sidewalls 320, convex sidewalls 330, and upper sidewalls 340.

Lower base 310 may be configured to be positioned between pairs of ears 142, below spool 150, and above or adjacent to a face of rotation disk, wherein ears 142 are positioned on opposite ends of rotational disk 140. Lower base 310 may have a length that is less than the distance between the pairs of ears 142, such that the ends of base 310 do not touch ears 142. In embodiments, a plane of lower base 310 may be configured to be tilted based on a desired angle of butterfly mount 160. Accordingly, in a first orientation a first end of lower base 310 may be positioned adjacent to rotational disk 140 and a second end of lower base 310 may be positioned away from rotational disk 140. In a second orientation, the second end of lower base 310 may be positioned adjacent to rotational disk 140 and the first end of lower base 310 may be positioned away from rotational disk 140. In a third orientation, the first and second ends may be at the same vertical offset way from the face of rotational disk 140, wherein lower base 310 is positioned on a plane that is parallel to the face of rotational disk 140.

Inner sidewalls 320 may be positioned on the sides of lower base 310. Inner sidewalls 320 may extend in a direction that is parallel to a longitudinal axis of shaft 120 and perpendicular to lower base 310. In embodiments, inner sidewalls 320 may include orifices, wherein the orifices are configured to allow spool 150 to traverse inner sidewalls 320. When lower base 310 is positioned between ears 142, there may be a space between inner sidewalls 320 and ears 142. In embodiments, inner sidewalls 320 may have a height that is long enough that when spool 150 traverses inner sidewalls 320, the tops of inner sidewalls 320 are positioned above the top of ears 142.

Convex sidewalls 330 may be sidewalls that are configured to diverge away from each other. In embodiments, convex sidewalls 330 may be angled at a desired forty five degree angle and having a length that is long enough to allow a pipeline to be positioned on convex sidewalls 330. In embodiments, the distal ends convex sidewalls 330 may be positioned at a location that is outside of the circumference of rotational disk 140, and the proximal end of convex sidewalls 330 may be positioned within ears 142.

Upper sidewalls 340 may be positioned on a distal end of convex sidewalls 330, and extend away from convex sidewalls 330 in a direction that is perpendicular to the longitudinal axis of shaft 120. Upper sidewalls 340 may have a sufficient length that allows tie orifices 170 to receive U-Bolts. The pipeline ties may extend around a circumference of a pipeline, wherein utilizing the pipeline ties and tie orifices 170, the pipeline may be secured within butterfly mount 160.

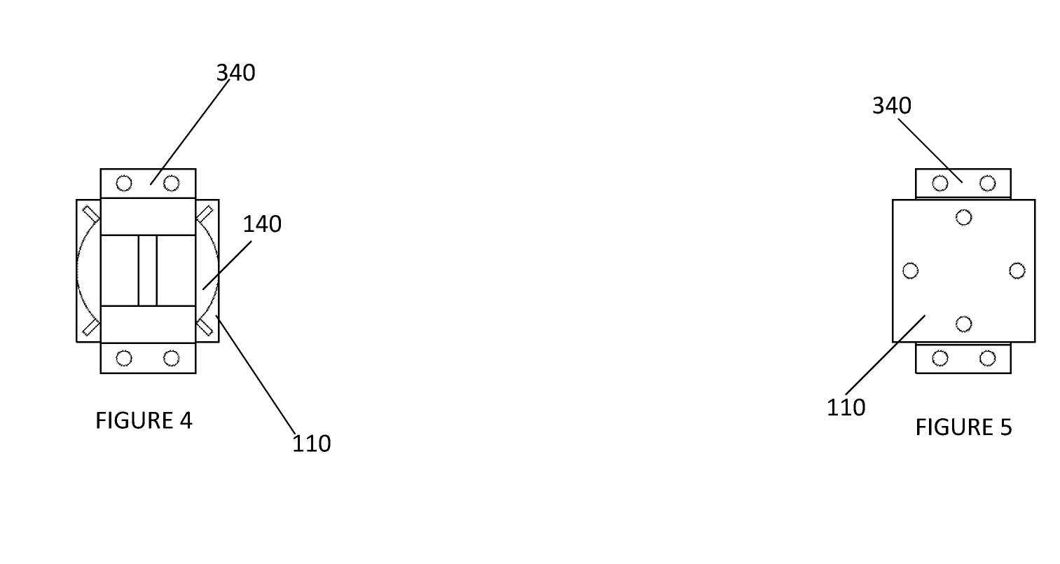

FIG. 4 depicts a top view of MAPSS 100 and FIG. 5 depicts a bottom view of MAPSS 100, according to embodiments. Elements depicted in FIGS. 4 and 5 may be discussed above. Therefore, for the sake of brevity, an additional description of these elements is omitted.

As depicted in FIGS. 4 and 5, upper sidewalls 340 may extend past the perimeter of base 110, and the other elements of pipeline support 110. Therefore, a pipeline that is wider than base 110 may be secured in place via butterfly mount 160.

Additionally, as depicted in FIGS. 4 and 5, the diameter of rotational disk 140 may be substantially the same as the length of base 110.

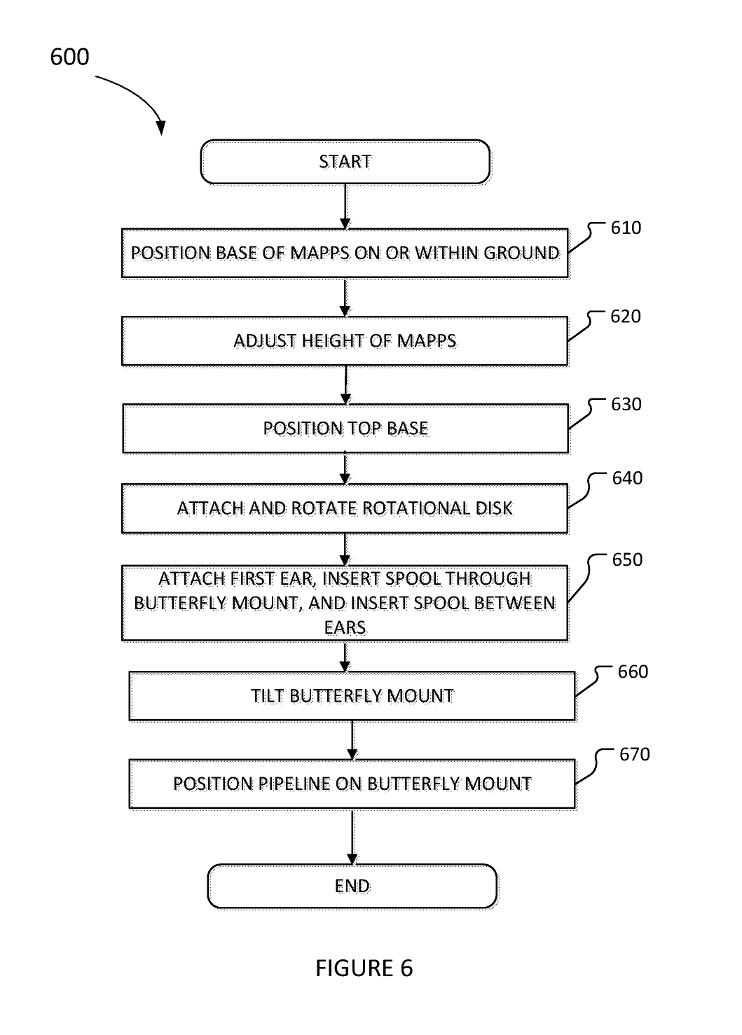

FIG. 6 depicts a method 600 for a utilizing a MAPSS. The operations of method 600 presented below are intended to be illustrative. In some embodiments, method 600 may be accomplished with one or more additional operations not described, and/or without one or more of the operations discussed. Additionally, the order in which the operations of method 600 are illustrated in FIG. 6 and described below is not intended to be limiting.

At operation 610, the base of the MAPSS may be positioned on or within a ground surface.

At operation 620, the height of the MAPSS may be adjusted based on the desired height of the pipeline. The height of the dynamic pipeline support may be adjusted via a telescopic shaft, and/or by rotating a threaded shaft within the base.

At operation 630, the top of a base of the MAPPS may be positioned.

At operation 640, a rotational disk may be rotated, such that the face of a butterfly mount is facing a desired direction. In embodiments, the rotational disk may be rotated a full three hundred and sixty degrees. Responsive to rotating the rotational disk to a desired direction, the rotational disk may be secured in place.

At operation 650, a first ear may be attached to the rotational disk. A spool may be inserted through the butterfly mount and the first ear. Then, a second ear may be attached, and the spool may be inserted through the second ear.

At operation 660, the butterfly mount may be tilted at a desired angle. The butterfly mount may be tilted at an upward angle or at a downward angle. In embodiments, the butterfly mount may be automatically tilted based on the weight of the pipeline without any human interaction.

At operation 670, a pipeline may be positioned over the butterfly mount, and secured to the pipeline support via ties. Responsive to the pipeline being positioned on the butterfly mount, the pipeline may dynamically change the tile of the butterfly mount based on the weight and angle of the pipeline. In embodiments, if warranted the pipeline may be secured to the butterfly mount via u bolts.

To disassembly the MAPSS, the process may be completed in reverse.

In alternative embodiments, butterfly mount may not include orifices to strap down a pipe with U-Bolts. This may allow for expansion and/or contraction of the pipe resting on the butterfly mount.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s).

What is claimed is:

1. A pipeline support system comprising:
a shaft mount configured to be coupled with a distal end of a shaft;
a circular platform positioned on an upper surface of the shaft mount, the circular platform including a plurality of locking orifices extending through the circular platform;
a plurality of fins with a first leg positioned on adjacent to the circular platform and a second leg positioned adjacent to a circumference of the shaft mount, the plurality of fins being configured to evenly distribute weight to the shaft mount, wherein no locking orifices are positioned directly above the first leg of the plurality of fins;
a rotational disk configured to be positioned adjacent to circular platform, the rotational disk including two ears positioned on opposite sides of the rotational disk, each of the ears including first spool orifices, the first spool orifices being vertically offset from an upper surface of the rotational disk;
a butterfly mount configured to support a pipeline, the butterfly mount including second spool orifices and convex sidewalls, wherein the butterfly mount is configured to be coupled with the rotational disk by positioning a spool through the first spool orifices and the second spool orifices, a first end of the convex sidewalls being configured to be positioned on a first side of the ears and a second end of the convex sidewalls being configured to be positioned on a second side of the ears.

2. The pipeline support system of claim 1, wherein the butterfly mount includes a lower base positioned between the ears, the lower base being configured to be freely tilted based on a desired angle of the pipeline.

3. The pipeline support system of claim 2, wherein in a first orientation a first end of the lower base is adjacent to the rotational disk and a second end of the lower base is positioned away from the rotational disk.

4. The pipeline support system of claim 2, wherein in a second orientation a first end of the lower base and a second end of the lower base are both positioned away from the rotational disk.

5. The pipeline support system of claim 1, wherein the convex sidewalls are positioned at a forty-five degree angle.

6. The pipeline support system of claim 1, wherein the rotational disk is configured to rotate to change the orientation of the butterfly mount.

7. The pipeline support system of claim 1, wherein a vertical height of the shaft is configured to change to modify a vertical offset of the butterfly mount.

8. The pipeline support system of claim 1, wherein outer sidewalls of the ears are positioned proximate to a circumference of the rotational disk.

9. The pipeline support system of claim 1, wherein the butterfly mount includes upper sidewalls positioned on the second end of the ears, the upper sidewalls extending in a direction perpendicular to a longitudinal axis of the shaft.

10. The pipeline support system of claim 9, wherein the upper sidewalls include tie orifices configured to receive u-bolts, the u-bolts being configured to extend around a circumference of the pipeline.

11. A method utilizing a pipeline support system comprising:
coupling a shaft mount with a distal end of shaft, the shaft mount including a circular platform positioned on an upper surface of the shaft mount, the circular platform including a plurality of locking orifices extending through the circular platform, the shaft mount also including a plurality of fins with a first leg positioned on adjacent to the circular platform and a second leg positioned adjacent to a circumference of the shaft mount, wherein no locking orifices are positioned directly above the first leg of the plurality of fins;
distributing weight evenly to the shaft mount via the plurality of fins
positioning a rotational disk on top of the circular platform, the rotational disk including two ears positioned on opposite sides of the rotational disk, each of the ears including first spool orifices, the first spool orifices being vertically offset from an upper surface of the rotational disk;
inserting a spool through the first spool orifices on the ears and second spool orifices on a butterfly mount to couple the butterfly mount with the rotational disk;
supporting a pipeline by positioning a pipeline on convex sidewalls on the butterfly, a first end of the convex sidewalls being configured to be positioned on a first side of the ears and a second end of the convex sidewalls being configured to be positioned on a second side of the ears.

12. The method of claim 11, further comprising:
freely tilting a lower base of the butterfly mount to a desired angle of the pipeline, the lower base being positioned between the ears

13. The method of claim 12, wherein in a first orientation a first end of the lower base is adjacent to the rotational disk and a second end of the lower base is positioned away from the rotational disk.

14. The method of claim 12, wherein in a second orientation a first end of the lower base and a second end of the lower base are both positioned away from the rotational disk.

15. The method of claim 11, wherein the convex sidewalls are positioned at a forty-five degree angle.

16. The method of claim 11, further comprising:
rotating the rotational disk to change the orientation of the butterfly mount.

17. The method of claim 11, further comprising:
changing a vertical height of the shaft to modify a vertical offset of the butterfly mount.

18. The method of claim 11, wherein outer sidewalls of the ears are positioned proximate to a circumference of the rotational disk.

19. The method of claim 11, wherein the butterfly mount includes upper sidewalls positioned on the second end of the ears, the upper sidewalls extending in a direction perpendicular to a longitudinal axis of the shaft.

20. The method of claim 19, further comprising:
inserting u-bolts into tie orifices on the upper sidewalls, the u-bolts extending around a circumference of the pipeline.
